(19) United States
(12) Patent Application Publication
(10) Pub. No.: US 2026/0025156 A1
(43) Pub. Date: Jan. 22, 2026

(54) CUSTOMIZATION AND APPEARANCE INFORMATION FOR WEARABLE METASURFACES

(71) Applicant: Dell Products L.P., Round Rock, TX (US)

(72) Inventors: Tejinder Singh, Manotick (CA); Navjot Kaur Khaira, Manotick (CA)

(21) Appl. No.: 18/775,999

(22) Filed: Jul. 17, 2024

(51) Int. Cl. H04B 1/08; G02B 1/00

(52) U.S. Cl. CPC H04B 1/086; G02B 1/002

(57) ABSTRACT

The technology described herein is directed towards a portable or wearable device/peripheral that includes a mask for a passive metasurface. A transceiver transmits a wireless radio frequency signal towards the metasurface, whereby the metasurface reflects an altered instance of the incoming signal back to the transceiver. The radiation pattern of the reflected signal can be distinct per metasurface, providing a distinct signature of that particular metasurface for detection by a computing device expecting that signature. The mask protects the passive metasurface, as well as determines the appearance of the metasurface. For example, the mask can show a manufacturer's logo, a user's preferred personal color, pattern, and so forth. The mask can include visible functionality information, such as what direction and range the metasurface should be with respect to the transceiver. Various wearable designs for the devices are described, including rings and wristbands that incorporate masked metasurfaces.

### RELATED APPLICATIONS

The subject patent application is related to U.S. patent application Ser. No. ______, filed ______, and entitled “PASSIVE WEARABLE DEVICE FOR SECURITY AND AUTHENTICATION” (docket no. 139008.01/DELLP1220US), U.S. patent application Ser. No. ______, filed ______, and entitled “SCALABLE AND COMPACT METASURFACE DESIGN FOR SMART AND FUNCTIONAL WEARABLE DEVICES” (docket no. 139009.01/DELLP1221US), U.S. patent application Ser. No. ______, filed ______, and entitled “INTEGRATED PHYSICAL DEVICE IDENTIFICATION FOR REMOTE MANAGEMENT OF WEARABLE METASURFACES” (docket no. 139010.01/DELLP1222US), U.S. patent application Ser. No. ______, filed ______, and entitled “DIFFERENTIATING PHYSICAL RADIATION PATTERNS IN PASSIVE METASURFACES” (docket no. 139011.01/DELLP1223US), U.S. patent application Ser. No. ______, filed ______, and entitled “COMPUTER PERIPHERAL WITH EMBEDDED TRANSCEIVER FOR PROXIMITY DETECTION OF WEARABLE METASURFACES” (docket no. 139013.01/DELLP1225US), U.S. patent application Ser. No. ______, filed ______, and entitled “PROXIMITY BASED MULTIFACTOR AUTHENTICATION USING PASSIVE WEARABLE METASURFACES” (docket no. 139014.01/DELLP1226US), U.S. patent application Ser. No. ______, filed ______, and entitled “AUTOMATIC COMPUTING DEVICE WAKE UP AND LOCK USING PASSIVE WEARABLE METASURFACE” (docket no. 139015.01/DELLP1227US), and U.S. patent application Ser. No. ______, filed ______, and entitled “SOFTWARE STACK AND BACKEND FOR PASSIVE WEARABLE METASURFACES FOR REMOTE MANAGEMENT AND ANALYTICS” (docket no. 139016.01/DELLP1228US), the entireties of which patent applications are hereby incorporated by reference herein.

### BACKGROUND

Existing wearable devices such as rings and wristwatches for activity tracking and/or health monitoring operate by establishing a communication link between the wearable device and a transceiver, generally using BLUETOOTH low energy technology. As such, these devices need electrical components such as a battery, various sensors, circuits, a controller, and antennas within the device, increasing the cost, size, and complexity in design. Moreover, due to the smaller battery size, these wearable devices need to be charged frequently.

### BRIEF DESCRIPTION OF THE DRAWINGS

The technology described herein is illustrated by way of example and not limited in the accompanying figures in which like reference numerals indicate similar elements and in which:

FIG. 1A is a block diagram representation of an example wearable device including a mask, and a passive metasurface communicating with a computing device via an embedded transceiver, in accordance with various example embodiments and implementations of the subject disclosure.

FIG. 1B is a block diagram representation of an example wearable device including a mask, and a passive metasurface communicating with a computing device via an external transceiver, in accordance with various example embodiments and implementations of the subject disclosure.

FIG. 2 is a representation of an example wearable device in the form of a ring design, in which the wearable device includes a passive metasurface that acts as a security/authentication key with respect to a computing device, in accordance with various example embodiments and implementations of the subject disclosure.

FIG. 3 is a representation of an example wearable device in the form of a ring design, highlighting the passive metasurface communicating with a transceiver embedded in a computing device, in accordance with various example embodiments and implementations of the subject disclosure.

FIG. 4 is a representation of an example surface designed for being implemented at 80 GHz, demonstrating the metasurface's compact and planar features, along with an enlarged portion representation thereof, and an enlarged unit cell representation, in accordance with various example embodiments and implementations of the subject disclosure.

FIG. 5A is a representation of an example wearable device in the form of a ring design with and without a mask attached, in accordance with various example embodiments and implementations of the subject disclosure.

FIG. 5B is an exploded view representation of an example unit cell stack for a metasurface of a passive wearable device that includes a mask layer, in accordance with various example embodiments and implementations of the subject disclosure.

FIG. 6 is a graphical representation of power versus frequency for an example passive metasurface device with a mask layer, indicating that no significant performance degradation caused by the mask layer is observable, in accordance with various example embodiments and implementations of the subject disclosure.

FIG. 7A is a representation of an example wearable device with a passive metasurface in the form of a wrist-wearable (e.g., wristband or bracelet) design, in accordance with various example embodiments and implementations of the subject disclosure.

FIG. 7B is a representation of an example passive portable device with a passive metasurface in the form of a design for affixing to a personal item (e.g., cell phone), in accordance with various example embodiments and implementations of the subject disclosure.

FIG. 8A is a representation of an example wearable device with a passive metasurface in the form of a neck-wearable (e.g., via a lanyard or necklace) design, in accordance with various example embodiments and implementations of the subject disclosure.

FIG. 8B is a representation of an example portable wearable device with a passive metasurface in the form of a design for affixing to a wearable item (e.g., eyeglass frames), in accordance with various example embodiments and implementations of the subject disclosure.

FIG. 9A is a three-dimensional perspective view representation of an example unit cell for a metasurface of a passive wearable device, in accordance with various example embodiments and implementations of the subject disclosure.

FIG. 9B is a representation of an example unit cell designs with geometry variations for different phase profiles, in accordance with various example embodiments and implementations of the subject disclosure.

FIG. 10 is a graphical representation of geometry length versus signal reflection for example passive metasurface device designs, in accordance with various example embodiments and implementations of the subject disclosure.

FIG. 11 is a graphical representation of geometry length versus signal reflection angle data for example passive metasurface device designs, in accordance with various example embodiments and implementations of the subject disclosure.

FIGS. 12A-12C are representations of example metasurfaces with various different design parameters to create distinct per device signatures, in accordance with various example embodiments and implementations of the subject disclosure.

FIG. 13A is a representation of an example wearable device in which a distinct device physical radiation pattern signature is included in a device service tag, in accordance with various example embodiments and implementations of the subject disclosure.

FIG. 13B is a representation of example unit cell designs with different length delay lines (stubs) arrayed for a distinct phase profile, in accordance with various example embodiments and implementations of the subject disclosure.

FIG. 13C is a representation of a map of the example unit cell designs with different length delay lines of FIG. 13A, in accordance with various example embodiments and implementations of the subject disclosure.

FIG. 14 is a graphical representation of different radiation patterns achieved from an example grating lobe-based beam-splitting metasurface, demonstrating the capability for a single reflected beam or a split beam from a wearable device with a passive metasurface, in accordance with various example embodiments and implementations of the subject disclosure.

### DETAILED DESCRIPTION

The technology described herein is generally directed towards incorporation of a mask layer with a wearable or otherwise portable metasurface that is capable of interacting with a receiver connected to a computing device, such as a personal computer or laptop. The mask can serve to protect the unit cells of the metasurface, as well as establish the overall appearance of the wearable device. Intuitive functionality icons also can be integrated onto the mask layer of any metasurface-embedded peripheral device, by which users are provided with visual cues and other information regarding the device's operation, such as, for example radiation direction and range of the device. Although in general the mask does not significantly compromise the performance characteristics of the metasurface, the choice of materials (based on permittivity and thickness) can somewhat change the performance characteristics, which can be compensated for by embedding information into the device's service tag that compensates for any performance characteristic changes.

In one implementation, the receiver is part of a dedicated transceiver that can be embedded into or otherwise coupled to the computing device. The transceiver, serving as the system's active component, emits a wireless radio frequency signal towards a metasurface integrated into the wearable device. Upon receiving the signal, the metasurface alters the incoming signal's properties in a predefined manner, and redirects (reflects) the altered instance of the signal back to the transceiver. Significantly, the wearable device and metasurface can be passive, requiring no internal or external power source to operate as a reflecting device. The receipt of the altered signal at the computing device facilitates detecting the proximity of the user, as well as possibly other actions such as authenticating the user, providing a seamless and intuitive user experience that is both efficient and secure. For example, the computing device can wake up or lock based on the presence or absence of the authenticated user, respectively.

The wearable device embedded with a metasurface or with a metasurface affixed thereto, can become a component in a user's daily attire, for example. In one implementation, the mask can be removable and/or interchangeable with another mask, such as with a different appearance, e.g., the mask can be a snappable outer cover.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in RF communications and RF devices in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

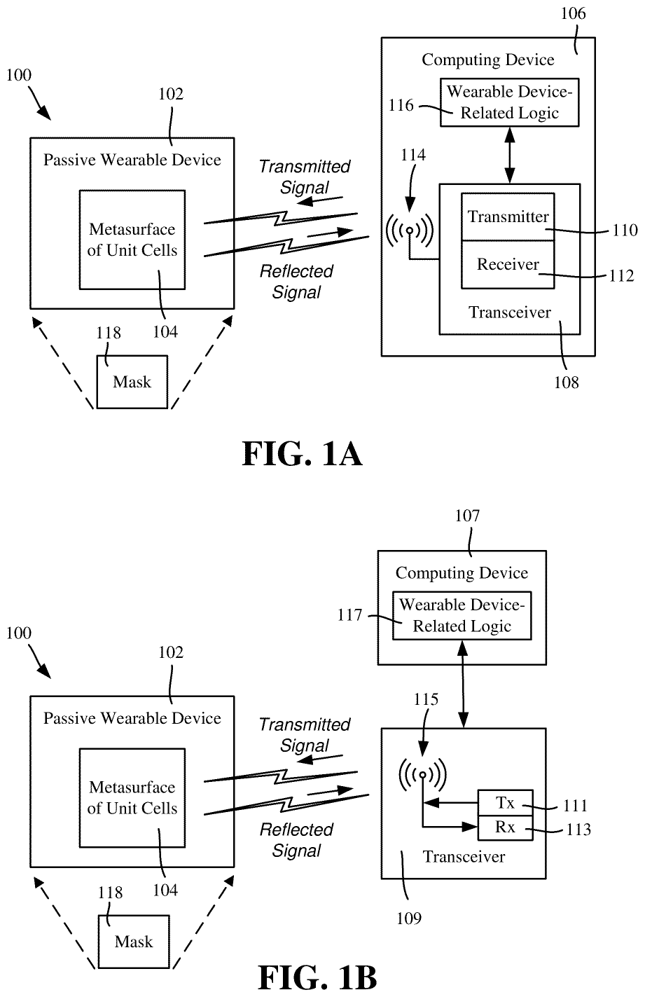

FIG. 1A is a block diagram representation of one example implementation of a system 100 in which a wearable device 102, which includes a metasurface of unit cells 104, communicates with a computing device 106. In the example of FIG. 1A, the computing device 106 includes an embedded, integrated or otherwise internal transceiver 108, which in turn includes a transmitter 110 and receiver 112. The transceiver components are coupled to an antenna 114 that transmits signals to the metasurface 104 of the passive wearable device 102, which as described herein, alters a reflected instance of the signal's characteristics to the transceiver's receiver 112. Based on the received signal, wearable device-related logic 116 (e.g., a hardware or software program running in the computing device 106) can analyze the reflected signal and take some action based thereon as described herein, such as to wake the operating system program or the like for execution in the computing device.

FIG. 1B is similar to FIG. 1A, except that a transceiver 109 (transmitter Tx 111/receiver Rx 113) is external to the computing device 107. For example, the external transceiver 109 can be designed as a universal serial bus (USB) device or other suitable device that plugs into a port of the computing device 109.

While a dedicated transceiver is one practical and convenient example, it should be noted that the transmitter and the receiver can be separate components. For example, consider an office setting where a single wall-mounted transmitter can transmit signals to multiple user work locations. Each user can share the same transmitter, yet have his or her own passive wearable device that reflects from the transmitter to a receiver. The users' respective computing devices can have respective external or internal receivers.

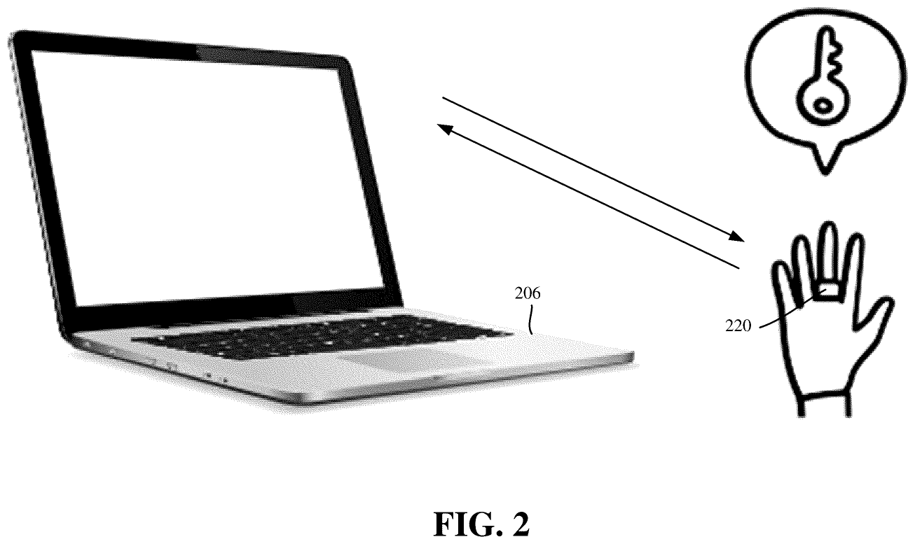

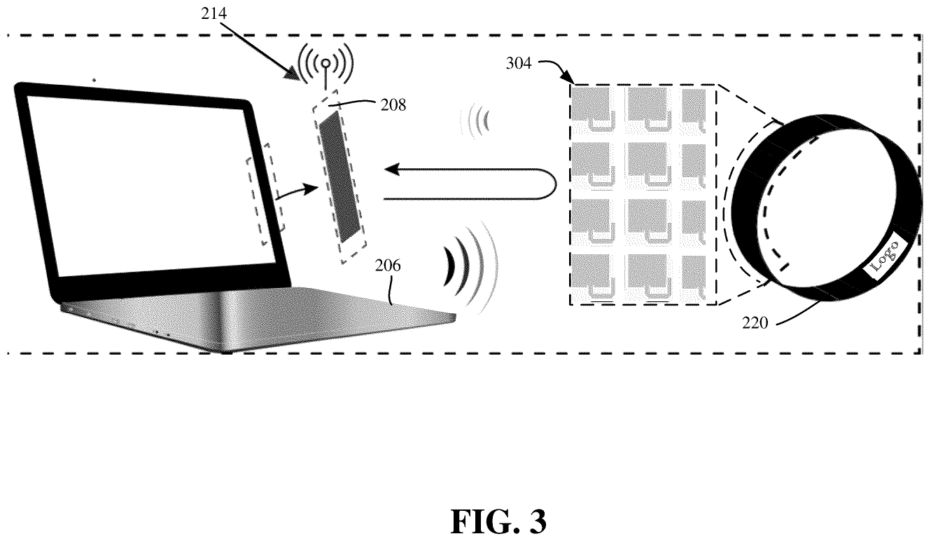

FIGS. 2 and 3 show the general concept of a ring-based wearable metasurface 220 interacting with a laptop computer 206. The ring-based wearable metasurface 220 can act as a key to lock and unlock the computer 206, for example, or at least detect the user's presence to wake the computer 206, such as to automatically open present an interactive lock screen when proximity is detected.

In the example of FIG. 3, a portion of the metasurface unit cells 304 is shown enlarged and interacting with a transceiver 208 (via antenna 214) integrated into the bezel or the like of the computer 206. In general, the user only needs to orient his or her hand at a reasonably close and suitable reflecting angle for the system to operate. Instead of the bezel, the transceiver 208 (or the antenna 214 coupled thereto) can be embedded into the lower portion of the laptop so that when interacting with the keyboard/mouse pad, the user's ring is naturally angled downward in a direction generally towards the antenna.

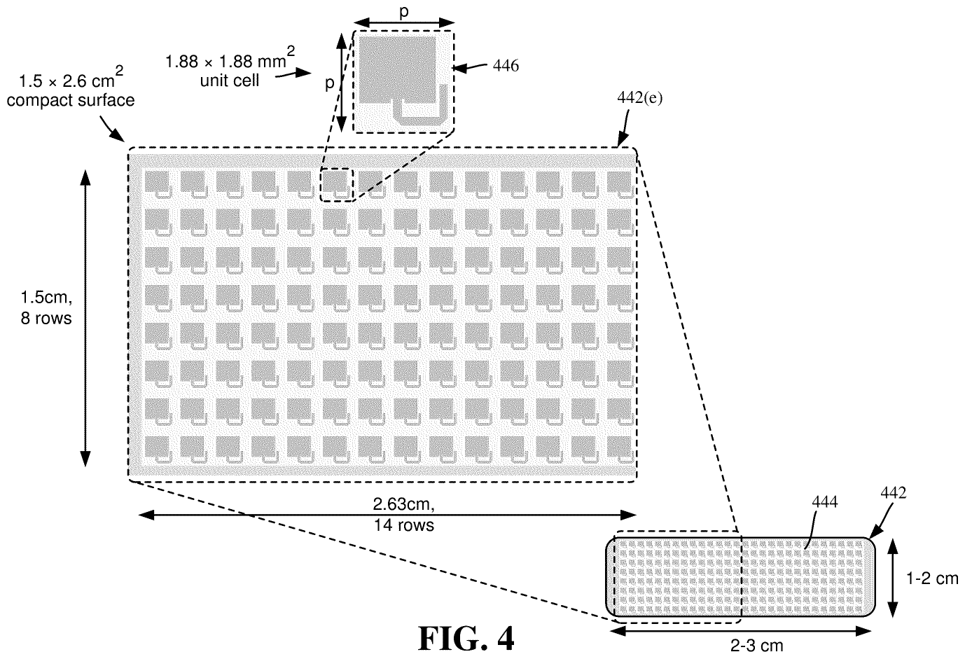

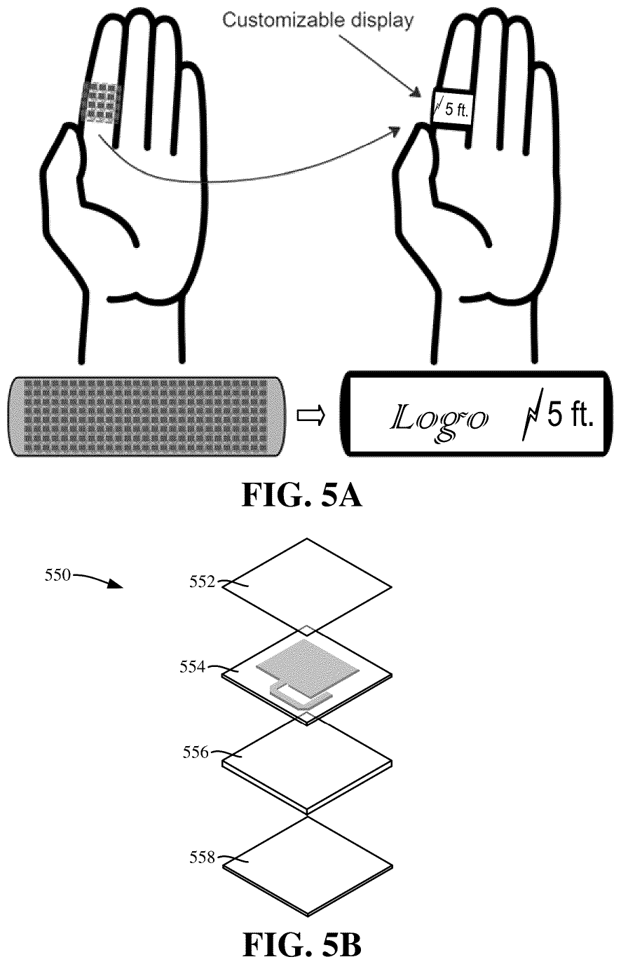

FIG. 4 shows an example wearable device 442 that incorporates a metasurface 444 with an 8×28 array of unit cells. An enlarged portion 442(e) highlighting an 8×14 unit cell array of the metasurface 444 is shown, and one of the unit cells 446 is enlarged. The dimensions shown in FIGS. 4 and 5 are based on a typical adult finger size and a frequency of 80 gigahertz (GHz). The fabrication tolerance of the metasurface design described herein makes this design easily scalable up to sub-terahertz frequencies, which is suitable for miniaturization to fit on a ring. As shown in FIG. 4, each unit cell in this example measures 1.88 mm×1.88 mm. These unit cells can be arranged in a matrix to fit within a ring that measures 1.5 cm in width and 2 to 3 cm in length when flattened. Additionally, the design is conformal, allowing for adjustments to accommodate bending of the surface, ensuring both flexibility and functionality in wearable applications.

In one example implementation, the metasurface is fabricated on flexible material (substrate and metallic ground plane) to facilitate forming the wearable device into a ring shape (FIG. 5A) suitable for wearing on a human finger. The example mask layer, shown on the right side of FIG. 5A, contains visible information, e.g., including a logo. Instead of or in addition to a logo, non-limiting visible information can include a brand identifier, an alphanumeric name (e.g., of the user), a service mark, an icon, an image, or a symbol.

Moreover, the visible information can provide descriptive functionality information related to characteristics of the device. For example, the radiation direction and range can be indicated by the orientation of the communications link symbol, and an approximate maximum distance (e.g., 5 feet (ft.)), respectively as also shown in the right side of FIG. 5A. The incorporation of functionality information (e.g., icons) facilitates improved user-friendliness by incorporating functionality icons to provide a user with visual cues and information regarding the device's operation, for example. Such icons/data on the mask layer serve as graphical indicators that convey functionality details in a clear and easily interpretable manner, empowering users to make informed decisions and effectively utilize the device's capabilities.

FIG. 5B is an exploded view of an example stack of the layers of a unit cell 550 of a metasurface. A mask layer 552 is above a metallic layer 554 that includes patch element and a metallic phase delay element, which in turn are supported by a substrate 556. A ground plane (panel) layer 558 complete the unit cell so that the unit cell will reflect the incoming signal (resonate at the desired frequency band) from the transceiver.

In general, the mask for the metasurface embedded peripherals (e.g., wearable devices) facilitates a customizable appearance of the peripheral without compromising performance, while also protecting the unit cells from dirt, dents, scratches, and so forth. The manufacturer, or (if available) the users thus have the ability to personalize the appearance of these devices without exposing the underlying metasurface. This customization feature allows for enhanced aesthetics and branding opportunities, while maintaining the functionality and performance of the metasurface. Metal-lookalike wearable devices, resin, matte, wood grain and so forth can be part of the patterns on the wearable devices.

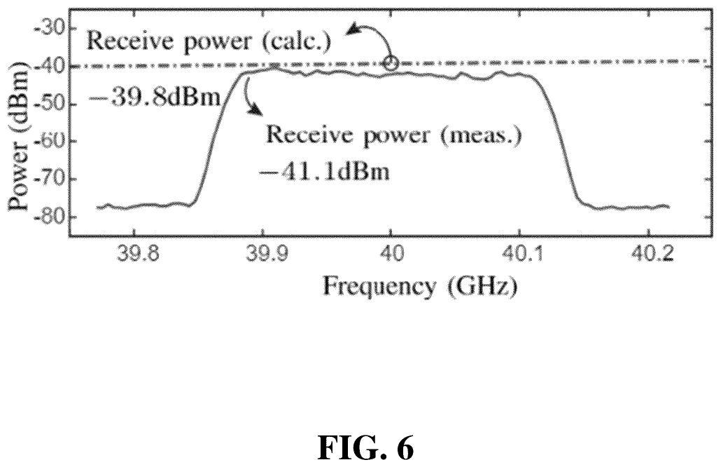

Significantly, rigorous manufacturing processes and experimental validation ensure that the performance of the metasurface remains uncompromised, thereby guaranteeing near optimal functionality and reliability regardless of the device's appearance customization. FIG. 6. Shows that the calculated receiver power versus the measured receiver power (via experimental validation of metasurface performance), with customizable masking, shows no observable performance degradation caused by the mask layer. However, different materials can be used that may cause some performance degradation; any such performance degradation can be taken into account and linked to the device identifier (device ID, described herein as a distinct ID per metasurface), such that the system already has this performance compensation information. for example, one type of mask material may reduce the array gain relative to another mask material, and the system can be informed of which type is in use and thus expect a larger or lesser gain in the expected performance characteristics for a particular device. Thus, one approach involves leveraging the choice of materials, to embed performance-related information within the device's service tag. This approach not only facilitates the customization of the device's appearance but also ensures that the selected materials contribute to optimized performance metrics, such as enhanced radiation efficiency and signal sensitivity; (that is, based on the material's permittivity and thickness, this information can be embedded in the device ID to take care of the performance gain or loss). Through the incorporation of this embedded information in the service tag, a user can seamlessly tailor a device's appearance to his or her preferences while simultaneously increasing the device's performance potential.

The appearance of a device can be customizable via the mask layer. For example, online platforms or communities can be established where users can share and collaborate on custom appearance designs for metasurface-embedded peripherals, fostering creativity, innovation, and community engagement. Such designs can be accessed by a manufacturer of the mask.

Further, the mask layer can be interchangeable with another mask layer, e.g., via snappable covers for the wearable devices. Any suitable mechanical or magnetic coupling can be used, for example, to allow straightforward detachment and attachment of the mask/cover.

Note that the device's distinct ID remains the same along with the metasurface performance signature; while adding various materials on top of the wearable device potentially can reduce the performance, this can be taken into account through an API (applet), e.g., by selling only a limited variation of such snappable covers, whereby the reduction of performance can be preset. Users can purchase multiple wearable masks and/or devices based on their personality or choice.

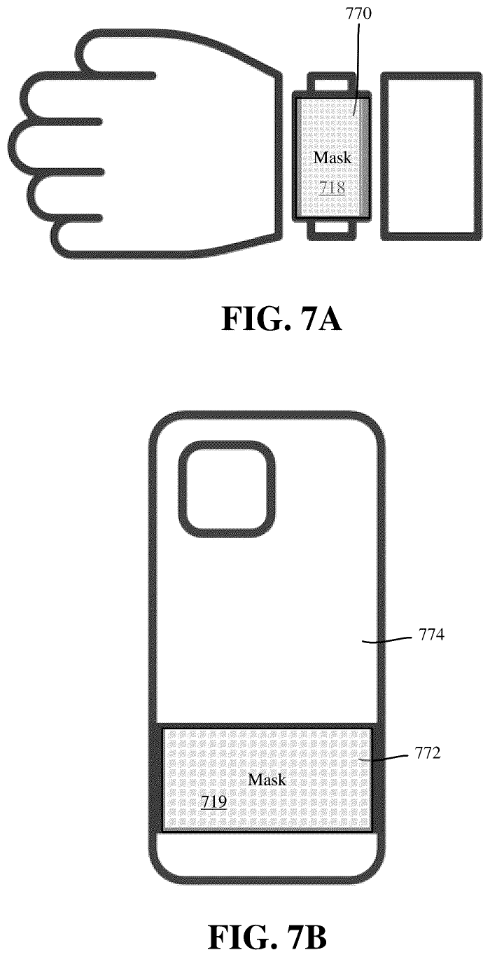

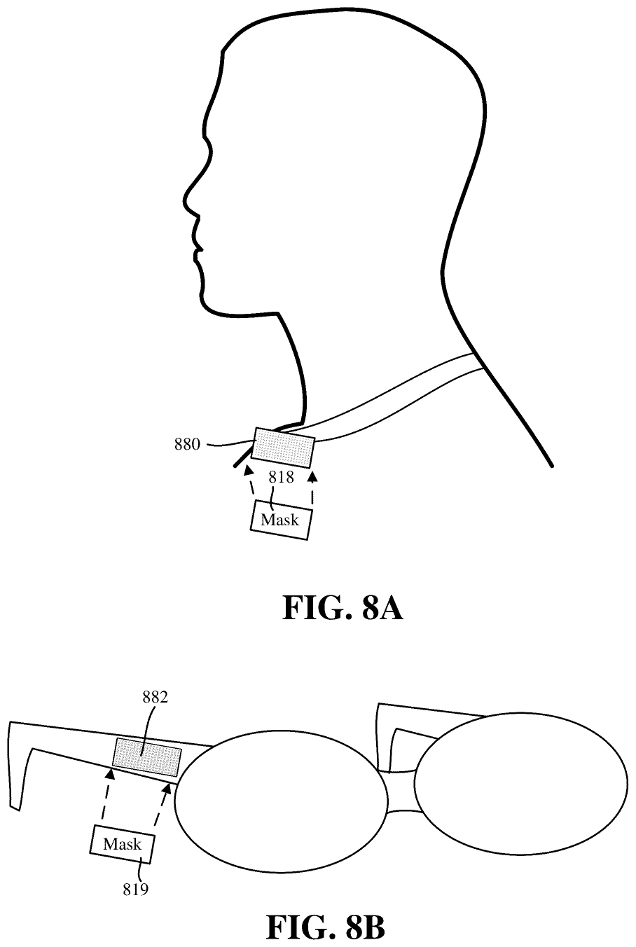

FIGS. 7A and 7B show alternative, non-limiting examples of wearable devices, namely a wrist-worn (e.g., wristband or bracelet) device 770 with a mask 718, and a portable device 772 with a mask 719 attached to a cell phone case 774. Although the portable device 772 attached to the cell phone case 774 is not “wearable” in the conventional sense, it can be considered “wearable” to the extent it accompanies a user and is typically part of the user's personal accoutrements that are generally within the user's possession, and indeed, can be “worn” in a user's pocket. FIGS. 8A and 8B show metasurfaces worn around a user's neck (e.g., as a necklace, locket or in lanyard) wearable device 880 with a mask 818, and a wearable device 882 with a mask 819 affixed to a user's eyeglass frame, respectively. Other non-limiting examples that are not explicitly shown include an identification badge, a name tag patch (e.g., affixed at a conference), a headset or headphones (e.g., regularly worn while working with a computer), and so on. Note that while the metasurface itself is passive, the metasurface can be coupled to a non-passive device, e.g., a watchband of a user's existing battery-powered wristwatch. Some example consideration factors when choosing among the wearable metasurface devices are summarized in the following table:

| User Needs | Product |
|---|---|
| Tranceiver Alignment | Ring |
| Gain | Wrist-worn Device |
| Convenience | Affixed/Embedded to Phone Case |

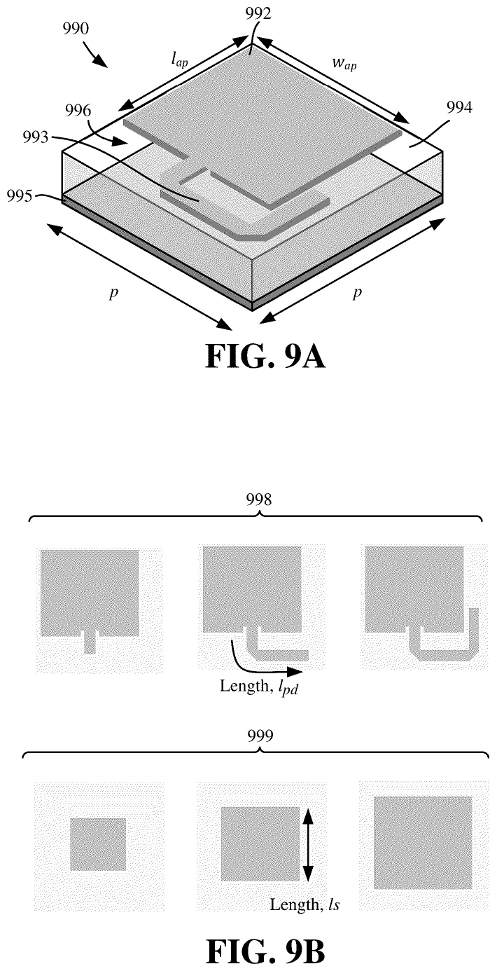

FIG. 9A shows a three-dimensional perspective view of one metasurface design 990 that includes a metallic patch element 992 and a metallic phase delay element 993. The metallic patch element 992 and the metallic phase delay element 993 are fabricated atop a substrate 994; a ground plane layer (panel) 995 beneath the substrate 994 in conjunction with the metallic patch element 992 provides an aperture 996 of length lₐₚ and width wₐₚ that facilitates passive operation of the unit cell 990. As is understood, an entire array of unit cells can be fabricated on a single substrate/ground plane.

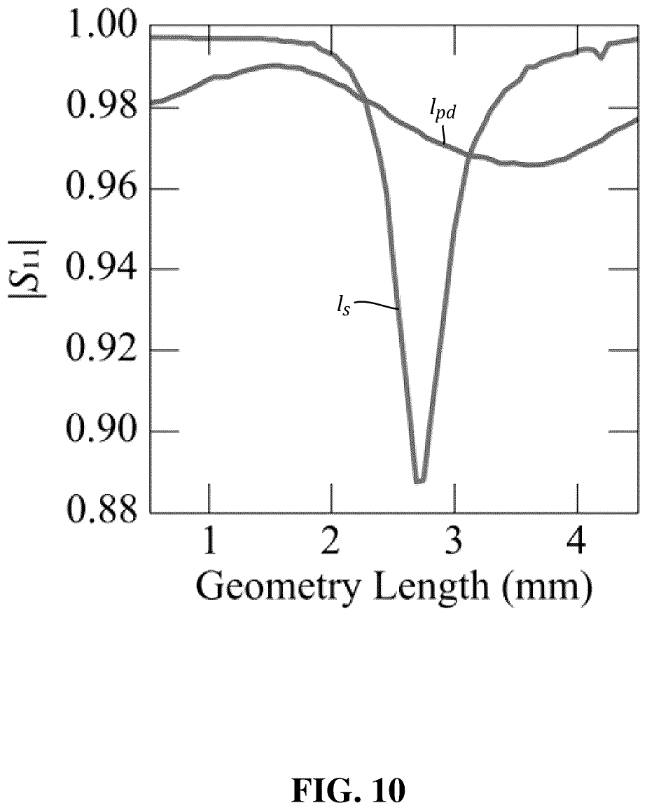

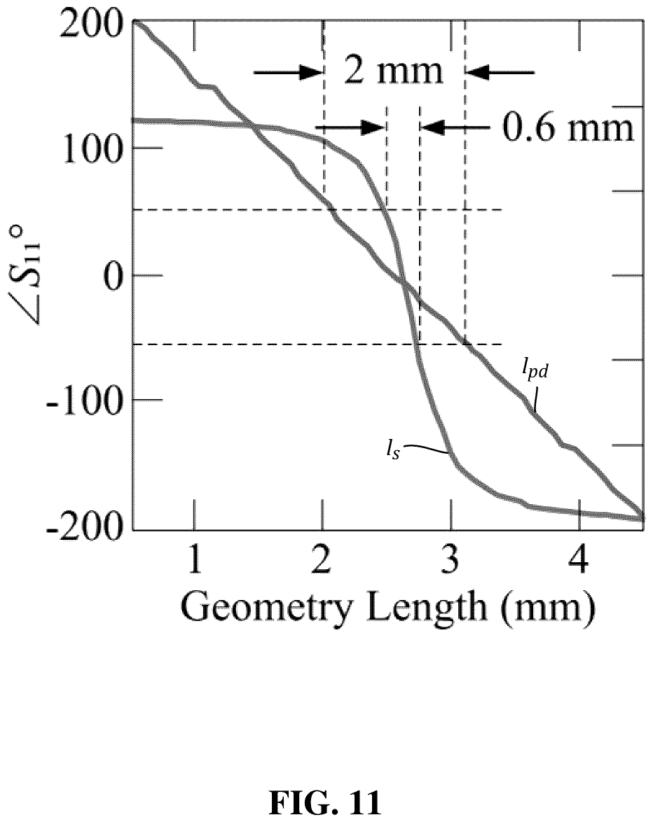

The length of the phase delay element 993 (i.e., metallic stub) adjusts the phase of the reflected signal. Such a phase delay element-based designs (999, FIG. 9B) overcome several challenges that regular variable-patch size approaches (999, FIG. 9B) encounter, as demonstrated by the simulation results shown in FIGS. 10 and 11. The simulation shows a full-wave numerical experiment result for an example unit-cell design using line-delay elements, which demonstrates phase delay element-based phase linearity compared to conventional size variation. The design was originally designed for 30 GHZ, with lₐₚ=2.93 mm, wₐₚ=3.31 mm, and p=5.01 mm

More particularly, FIGS. 10 and 11 highlight how the patch size variation approach designs 999 (without delay lines) suffer from phase errors, due to a combined effect of fabrication tolerance and the rapid phase variation near resonance. As shown in FIG. 11, the phase undergoes a 100 degree change within a mere 0.6 mm range. With typical fabrication tolerances between 0.07 to 0.20 mm (3-8 mil), this design is prone to phase errors, particularly at higher frequencies and/or when using cost-effective, lower precision manufacturing techniques. In contrast, the phase delay element designs 998 (FIG. 9B) with delay lines exhibit a flatter amplitude profile and a linear phase trend, as also shown in FIGS. 10 and 11, respectively. The phase shift with the phase delay element design approach 998 is proportional to twice the line length, offering significantly more reliable and consistent performance.

The phase delay element implementation design is appropriate for high frequency operation in that the design reduces the physical size and minimizes interference. More particularly, a metasurface design uses the phase delay element for tuning reflected signals' phase for high frequency operation, which enhances device compactness, aesthetic integration, and reduces interference by avoiding crowded spectral bands. At the same time, the design facilitates straightforward fabrication with the metallic patch element and phase delay element with a conformal design for versatile integration. Designing the length of the phase delay element for tuning not only cases the manufacturing process, but also significantly enhances the fabrication tolerances, which can significantly reduce barriers to innovation and deployment. The metasurface design's conformal nature is beneficial in wearable technology.

A wearable device can have information encoded into its reflected signal based on how the reflected signal is altered by the metasurface relative to the transmitted signal. More particularly, any device can be crafted with a distinct metasurface pattern that distinguishes that metasurface from others. The distinct identifiability of each device is based on its physical radiation characteristics, in that each metasurface can generate a distinct radiation pattern in the reflected signal, which differentiates each such metasurface while ensuring that each metasurface can uniquely interact with the corresponding system.

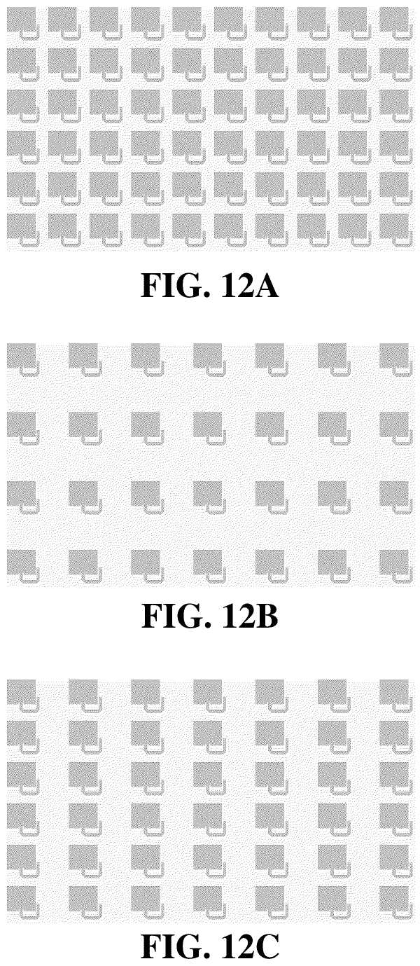

To this end, each device can be manufactured with a system-unique set of metasurface scatters (or simply unit-cells) to provide variations in terms of phase, gain, beam patterns, dual beam splitting, directivity, and the like which can be achieved by altering the unit-cell shape, phase, size, spacing, rotation, among other characteristics, as shown in FIGS. 12A-12C; the characteristics can be unique and randomized/or altered according to a controlled pseudorandom pattern. For example, the example metasurface of FIG. 12A can be considered a standard metasurface, while the more spaced-apart unit cells of FIG. 12B (relative to FIG. 12A) can provide a variation on the beam width. The horizontal spacing and vertical spacing differences in FIG. 12C can result in asymmetric beam splitting based on grating lobes (resulting in variations on the number of reflected beams and their angles).

An advantageous characteristic of the wearable technology described herein is the scalable design of the metasurface, which can be adapted to fit various sizes and types of wearables. The flexibility to customize the size of the metasurface based on the surface area of the wearable item enables a tailored approach to meet specific user needs. Further, as described with refence to FIGS. 12A-12C, there can be a distinct per-device performance signature, possibly globally unique, by which each device is manufactured with a different set of metasurface scatters (i.e., unit-cells) to provide variations in terms of phase, gain, beam patterns, multiple (e.g., dual) beam splitting, directivity and the like, which can be achieved by altering the unit-cell shape, phase, size, spacing, rotation and so forth.

This distinct performance signature can be linked to a system-unique device ID, in which the system expects to detect the predetermined performance signature when the wearable device is linked to the user's computing device and/or associated account. For example, the wearable device-related logic 116 (FIG. 1A) or 117 (FIG. 1B) can look for an expected radiation pattern and match it to a user account; if not matched, or no signal is reflected, metasurface-based access is denied, although another way to access the account may be enabled, such as if the user has forgotten to wear the device. There also can be shared access to a computing device, and thus the logic can map one radiation pattern signature to one authorized user of that computing device and to that user's profile/account, and map a different radiation pattern signature to another authorized user of that computing device and to that other user's profile/account.

Among the benefits of distinct metasurfaces and their corresponding distinct physical radiation patterns is with respect to integrated physics device identification for remote management of wearable metasurfaces. A concern regarding the security of a system as described herein is to ensure that only a specific, authorized wearable device can unlock the system/account, rather than just any wearable device. To address this, each device can be crafted with a different metasurface pattern that distinguishes it from others.

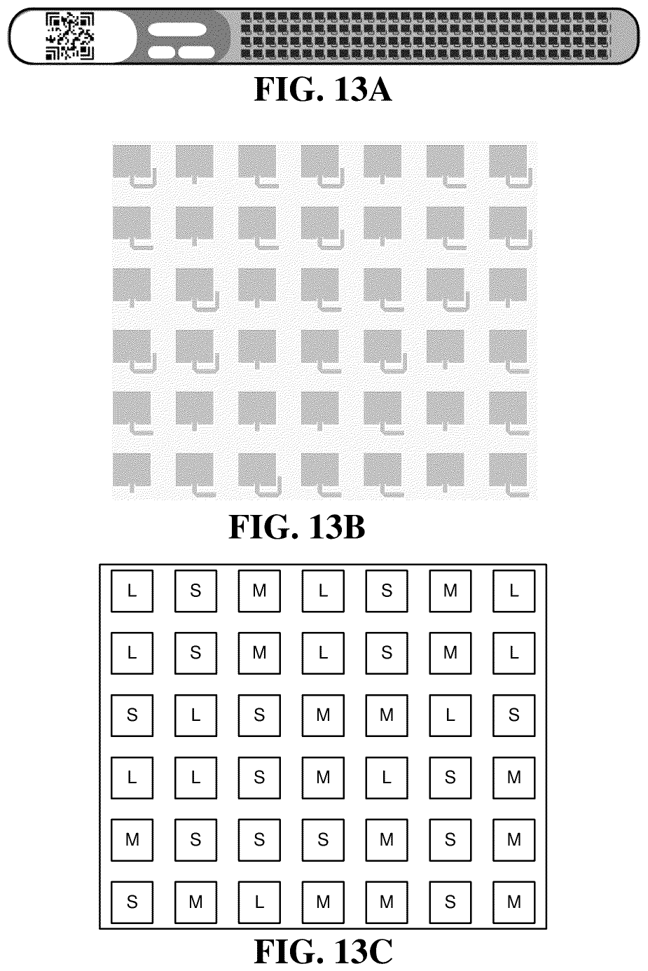

The distinct identifiability via customized radiation characteristics also facilitates the association of a service tag encoding for individual metasurface identification. By way of example, consider that the customized radiation characteristics can encode/correspond to a number of (e.g., seven) alphanumeric characters, that encode the specific differences in each metasurface's design, such as appearance, materials, location, antenna patterns, beam splitting nature, range, and so forth. Individual performance parameters can be encoded as well. An example metasurface with an associated service tag that is also encoded in the customized radiation characteristics is shown in FIG. 13A.

This customization involves distinct radiation patterns generated by each metasurface, tailored specifically to each device ID. This device ID can be incorporated or encrypted within an enterprise's service tag mechanism. For example, because peripherals do not need a separate service tag, a device ID in case of a wearable device is desirable to distinguish the physical features, internal metasurface design patterns, beam patterns, materials, location, and in general for remote management, including activation of the device when purchasing or deactivation in case if the device gets lost.

With respect to improved security and privacy, leveraging the distinct signal manipulation capabilities of metasurfaces, the technology described herein offers an advanced level of security. The complexity and customization potential of the reflected signals make it extremely challenging for unauthorized entities to mimic or hack. Indeed, the different characteristics of each ring or wearable device, achieved through specific customization of the radiation characteristics, can include the beam width (angular scan range) and the asymmetric beam splitting, which varies according to the number of beams and their specific angles. This ensures that each ring interacts individually with the system, providing a secure and personalized method of access.

As a further example, in addition to the spacing differences described with reference to FIGS. 12A-12C, consider the different patterns of unit cell delay line (stub) lengths shown in FIG. 13B. FIG. 13C shows a map of the lengths, e.g., S (short), M (medium) and L (long) which can be distinctly arranged per metasurface. The pattern of the length arrangements of FIG. 13B, which results in one particular phase profile, can be varied for another device, and so on, providing another variable characteristic that modifies the physical radiation pattern of the reflected signal relative to the transmitted signal. Note that while three different delay line lengths are depicted, there can be more than three different lengths, providing even more variations in phase profiles among metasurfaces.

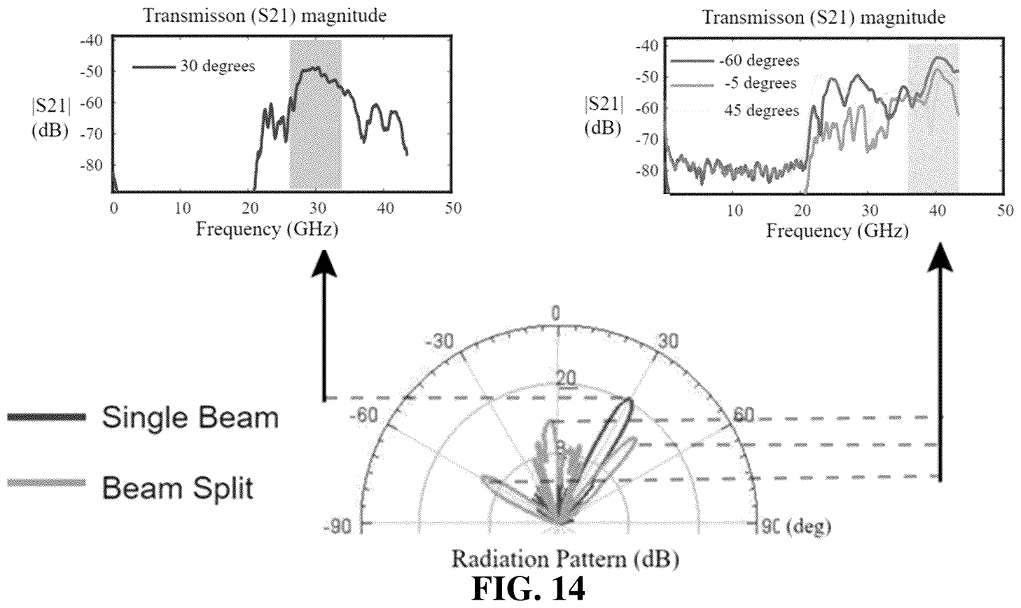

FIG. 14 shows a different radiation pattern achieved from a metasurface configured for beam splitting. The frequency is tunable based on the metasurface unit cell size.

One or more example embodiments can be embodied in a device, such as described and represented herein. The device can include respective unit cells configured to redirect transmitted wireless radio frequency signals, received at the respective unit cells from a transmitter, as redirected wireless radio frequency signals to a receiver, a substrate layer beneath the respective unit cells, a ground plane layer beneath the substrate layer, and a mask layer above the respective unit cells; the mask layer augments an appearance of the device.

The mask layer can be substantially transparent to the transmitted wireless radio frequency signals and the redirected wireless radio frequency signals.

The device can be configured to be a wearable device.

The respective unit cells, the substrate layer, the ground plane layer and the mask can be flexible, resulting in the device capable of being curved to facilitate wearing of the device by a user.

The mask layer can contain visible information. The visible information can include at least one of: a logo, a brand identifier, an alphanumeric name, a service mark, an icon, an image, or a symbol. The visible information can correspond to descriptive functionality information related to characteristics of the device. The visible information can be customizable, with a representation of the visible information accessible via a shared platform.

The mask layer can be attachable and detachable from the device.

The mask layer can include a first interchangeable mask layer, and further can include a second interchangeable mask layer that is attachable and detachable from the device.

The mask layer can be based on at least one of: permittivity of a selected material, or thickness of the selected material, to determine, at least in part, performance metrics of the device that determine a radiation pattern of the redirected wireless radio frequency signals.

The unit cells can alter a radiation pattern of the redirected wireless radio frequency signals relative to the transmitted wireless radio frequency signals, to operate the device, at least in part, as a service tag that encodes device information in the radiation pattern.

One or more example embodiments can be embodied in a metasurface, such as described and represented herein. The metasurface can include respective unit cells that redirect transmitted wireless radio frequency signals, transmitted by a transmitter and impinging on the passive metasurface, as reflected wireless radio frequency signals back for receiving by the receiver, a mask that covers the respective unit cells, a substrate layer beneath the respective unit cells, and a ground plane layer beneath the substrate layer. The respective unit cells can alter the reflected wireless radio frequency signals relative to the transmitted wireless radio frequency signals based on respective characteristics of the respective unit cells to encode information, corresponding to performance metrics of metasurface, in the reflected wireless radio frequency signals.

The metasurface can be wearable by a user.

The mask can establish an appearance of the metasurface.

The mask can be interchangeable with at least one other mask.

The mask can include visible information.

One or more example embodiments can be embodied in a device, such as described and represented herein. The device can include a unit cell layer comprising unit cells that redirect transmitted wireless radio frequency signals, received at the unit cells from a transmitter, as redirected wireless radio frequency signals to a receiver, a substrate layer beneath the respective unit cells, a ground plane layer beneath the substrate layer, and a coupling. The coupling can be configured for interchangeably attaching a mask to the device above the unit cells; when the mask is coupled to the device via the coupling, the mask layer protects the unit cells from physical damage, in conjunction with altering an appearance of the device.

The coupling can include at least one of: a mechanical coupling, or a magnetic coupling.

The mask can be a first mask corresponding to a first appearance of the device when the first mask is coupled to the device via the coupling, and further can include a second mask corresponding to a second appearance of the device when the second mask is coupled to the device via the coupling.

As can be seen, the technology described herein is directed to a mask for user wearable/portable devices, such as for seamless authentication on digital computing devices such as a laptop/desktop PC. The mask protects and determines the appearance of a passive metasurface, in which the metasurface enhances personal security and facilitates seamless interaction with digital environments. Metasurfaces, being engineered interfaces, manipulate electromagnetic waves in ways that traditional materials cannot, without requiring any power source, making them very suitable for passive operations in wearable technology, as well as facilitating distinct radiation patterns per metasurface. The mask can include personal as well as functional visible information, and can be interchangeable.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A device, comprising:
respective unit cells configured to redirect transmitted wireless radio frequency signals, received at the respective unit cells from a transmitter, as redirected wireless radio frequency signals to a receiver;
a substrate layer beneath the respective unit cells;
a ground plane layer beneath the substrate layer; and
a mask layer above the respective unit cells, wherein the mask layer augments an appearance of the device.

2. The device of claim 1, wherein the mask layer is substantially transparent to the transmitted wireless radio frequency signals and the redirected wireless radio frequency signals.

3. The device of claim 1, wherein the device is configured to be a wearable device.

4. The device of claim 1, wherein the respective unit cells, the substrate layer, the ground plane layer and the mask are flexible, resulting in the device capable of being curved to facilitate wearing of the device by a user.

5. The device of claim 1, wherein the mask layer contains visible information.

6. The device of claim 5, wherein the visible information comprises at least one of: a logo, a brand identifier, an alphanumeric name, a service mark, an icon, an image, or a symbol.

7. The device of claim 5, wherein the visible information corresponds to descriptive functionality information related to characteristics of the device.

8. The device of claim 5, wherein the visible information is customizable, with a representation of the visible information accessible via a shared platform.

9. The device of claim 1, wherein the mask layer is attachable and detachable from the device.

10. The device of claim 9, wherein the mask layer comprises a first interchangeable mask layer, and further comprising a second interchangeable mask layer that is attachable and detachable from the device.

11. The device of claim 1, wherein the mask layer is based on at least one of: permittivity of a selected material, or thickness of the selected material, to determine, at least in part, performance metrics of the device that determine a radiation pattern of the redirected wireless radio frequency signals.

12. The device of claim 1, wherein the unit cells alter a radiation pattern of the redirected wireless radio frequency signals relative to the transmitted wireless radio frequency signals, to operate the device, at least in part, as a service tag that encodes device information in the radiation pattern.

13. A metasurface, comprising:
respective unit cells that redirect transmitted wireless radio frequency signals, transmitted by a transmitter and impinging on the passive metasurface, as reflected wireless radio frequency signals back for receiving by the receiver;
a mask that covers the respective unit cells;
a substrate layer beneath the respective unit cells; and
a ground plane layer beneath the substrate layer,
wherein the respective unit cells alter the reflected wireless radio frequency signals relative to the transmitted wireless radio frequency signals based on respective characteristics of the respective unit cells to encode information, corresponding to performance metrics of metasurface, in the reflected wireless radio frequency signals.

14. The metasurface of claim 13, wherein the metasurface is wearable by a user.

15. The metasurface of claim 13, wherein the mask establishes an appearance of the metasurface.

16. The metasurface of claim 13, wherein the mask is interchangeable with at least one other mask.

17. The metasurface of claim 13, wherein the mask comprises visible information.

18. A device, comprising:
a unit cell layer comprising unit cells that redirect transmitted wireless radio frequency signals, received at the unit cells from a transmitter, as redirected wireless radio frequency signals to a receiver;
a substrate layer beneath the respective unit cells;
a ground plane layer beneath the substrate layer; and
a coupling configured for interchangeably attaching a mask to the device above the unit cells, wherein when the mask is coupled to the device via the coupling, the mask layer protects the unit cells from physical damage, in conjunction with altering an appearance of the device.

19. The device of claim 18, wherein the coupling comprises at least one of: a mechanical coupling, or a magnetic coupling.

20. The device of claim 18, wherein the mask is a first mask corresponding to a first appearance of the device when the first mask is coupled to the device via the coupling, and further comprising a second mask corresponding to a second appearance of the device when the second mask is coupled to the device via the coupling.
